(19) United States
(12) Patent Application Publication
(10) Pub. No.: US 2009/0121452 A1
(43) Pub. Date: May 14, 2009

(54) Extension Coupling With Angle Adjusting Retainer For Use With Trailers

(76) Inventor: William M. Zilm, Glenwood Springs, CO (US)

Correspondence Address: HOLLAND & HART, LLP, P.O BOX 8749, DENVER, CO, 80201, US

(21) Appl. No.: 11/939,468

(22) Filed: Nov. 13, 2007

(51) Int. Cl. B60D 1/02

(52) U.S. Cl. 280/515

(57) ABSTRACT

An extension coupling for interconnecting a trailer to a tow hitch with an angular opening including a mount securable to the trailer and an elongated arm having a proximal end portion rotatably attached to the mount and an opposite distal end portion. A connector pin is disposed on the distal end portion and adapted to releasably mate with the tow hitch. A retainer is mounted to the elongated arm and includes a head assembly operative to engage the angular opening of the tow hitch thereby to resist rotation of the arm relative to the tow hitch. The head assembly includes first and second faces respectively oriented at an angle with respect to one another. The faces are movable with respect to one another so as to change the angle between a larger angle and a smaller angle to correspond to the angular opening in the tow hitch.

### FIELD OF THE INVENTION

The exemplary embodiment of the present invention broadly concerns the interconnection of a trailer to a tractor vehicle for towing. More particularly, however, the exemplary embodiment of the present invention concerns trailer-hitch assemblies for travel trailers. The embodiment is specifically directed to a fifth wheel hitch mountable to a tractor vehicle and an extension assembly that couples thereto.

### BACKGROUND

For many years, recreational traveling has enjoyed popularity among a wide spectrum of the population. A concern for any traveler, naturally, is to provide for basic needs such as food and shelter. A significant portion of the hotel/motel industry caters to the traveler's need for shelter while the restaurant provides the availability of food and drink.

Despite the availability of overnight accommodations at hotels, motels, and the like, many travelers seek alternative accommodations either as a life-style preference or as a money saving measure. Also, convenient hotel/motel lodgings are not always available at target recreation sites so that alternative accommodations must be made. In such cases, many travelers prefer to use their own accommodations that they transport with them.

While the simplest form of portable accommodations may be the tent, many travelers find tents to be inconvenient or uncomfortable. Accordingly, many travelers opt for other portable accommodations such as tent trailers, truck mounted campers, recreational vehicles, and the travel trailers known as fifth-wheel travel trailers.

As is known, a fifth-wheel travel trailer is, essentially, a small self-contained home, which may be towed to a desired location by any suitable tractor vehicle, for example, a pick-up truck. The forward portion of the travel trailer is provided with a downwardly depending hitch box and downwardly projecting kingpin or connector pin. This kingpin is sized and adapted to mate with a standard fifth-wheel hitch that is mounted on the tractor vehicle. Thus, the tractor vehicle supports the travel trailer so that its forward end is elevated above the surface of travel, such as a roadway, while the rear portion of the vehicle is supported on a wheel set so that it may travel over the surface.

The substantial weight of the fifth-wheel travel trailer requires proper loading and mounting of the hitch assembly. Where the typical pick-up truck is employed as the tractor vehicle, the fifth-wheel tow bed hitch is secured in the bed of the pick-up truck above and slightly in front of the rear axle. It is important that the mounting not be located too far forward of the axle to avoid unnecessary bending moments about the axle. Moreover, it is important not to mount the hitch rearwardly of the axle otherwise the tractor vehicle will tend to rear off its front wheels resulting in loss of steering control.

Where a long-bed truck is employed as the tractor vehicle, relatively few difficulties are encountered in the proper mounting of a bed hitch for a fifth-wheel trailer. Recently, though, the popularity of the short-bed pick-up truck has grown. Here, there is a decreased distance between the rear axle of the pick-up truck and the cab. In such cases, as discussed more thoroughly below, the proper mounting of the bed hitch results in an inadequate clearance distance between the forward portion of the fifth-wheel trailer and the truck cab. In order to achieve adequate clearance, the tow hitch may be moved rearwardly in the bed, behind the rear axle. However, as noted above, this creates an undesirable and potentially dangerous towing configuration.

In my U.S. Pat. No. 5,890,728 issued Apr. 6, 1999, I disclose an extension coupling for use with trailers. This extension coupling mounts to the standard hitch box on the trailer and includes a forwardly projecting elongated arm that has a proximal end pivotally connected to the mount and a distal end that has a connecting pin or kingpin. The connecting pin engages the standard tow hitch. A retainer assembly is secured to the arm and engages the tow hitch when the trailer is interconnected to the tractor vehicle so as to resist rotation of the arm relative to the tow hitch. In order to engage the tow hitch such that it resists rotation, the retainer assembly must mate securely with the kingpin receiver as well as the V-shaped opening in the receiver plate. The distance between the kingpin receiver and the V-shaped opening, as well as the angle of the V-shaped opening both vary among manufacturers and load ratings.

In my earlier patent, the retainer assembly was structured as a fixed-shape wedge that was forwardly biased by a compression spring. This wedge engaged the V-shaped opening of the receiver plate. The restorative force of the compression spring helped resist rotation of the elongated arm relative to the hitch. However, since the angle of the V-shaped openings of hitches from different manufacturers varies, the wedge was not universal for all applications.

While the extension coupling taught in my earlier patent has proved to be a viable solution to the problem of towing trailers with short bed trucks, the present disclosure improves upon such coupling by utilizing an improved retainer assembly and trailer incorporating the same. More particularly, the exemplary embodiment of the present invention addresses this need by providing an improved fifth-wheel tow hitch that adapts to a range of V-shaped opening angles and V-shaped opening to kingpin receiver spacings.

### SUMMARY OF THE EXEMPLARY EMBODIMENT

Provided is an extension coupling for releasably interconnecting a trailer to a tow hitch having an angular opening. The extension coupling includes a mount which is adapted to be secured to the trailer and an elongated arm having a proximal end portion rotatably attached to the mount and a distal end portion opposite the proximal portion.

A connector pin is disposed on the distal end portion and adapted to releasably mate with the tow hitch. The connector pin projects from the distal end portion along a pin axis. A retainer is mounted to the elongated arm and associated with the connector pin.

The retainer includes a head assembly operative to engage the angular opening of the tow hitch thereby to resist rotation of the arm relative to the tow hitch. The head assembly provides first and second faces respectively oriented in first and second planes that are at an angle with respect to one another. These faces are movable with respect to one another so as to change the angle between a larger angle and a smaller angle in order to correspond to the angular opening in the tow hitch.

The retainer may also include a rail disposed on the arm for slideably securing the head member to allow movement toward and away from said connector pin. The rail may have a dovetail cross-section wherein the head member has a dovetail channel sized and adapted to engage the rail.

The head assembly may be slideably mounted to the elongated arm and may be spring biased toward the connector pin. The head member may include a cavity in which the spring can be located. The rail may include a spring stop projecting into the cavity where the spring has one end supported by the spring stop.

The head assembly may include a head member which has first and second pivot members pivotally disposed on the head member. The first and second pivot members provide first and second faces and are operative to pivot between a first position, corresponding to a large angle, and a second position, corresponding to a small angle. The head assembly may be structured as a wedge where the first and second pivot members are biased toward the first position.

The mount which is secured to the trailer may include a flat base plate and a pair of upwardly projecting side plates disposed on the base plate in spaced apart opposed relation to one another. The side plates being sized and adapted to releasably engage the hitch connecting station.

### BRIEF DESCRIPTION OF THE DRAWINGS

FIG. 1 is a perspective view of a fifth-wheel travel trailer being towed by a tractor vehicle having a short box bed according to the prior art;

FIG. 2 is a side view in partial cross-section showing the mounting of the fifth-wheel trailer of FIG. 1 to the bed of the tractor vehicle according to the prior art;

FIG. 3 is a top plan view of the prior art truck and trailer combination of FIG. 1 with the trailer being towed in a straight line;

FIG. 4 is a top plan view of the truck and trailer combination of FIGS. 1 and 3 showing its reduced turning radius;

FIG. 5 is a perspective view of the extension coupling according to the present invention;

FIG. 6 is a side view in elevation of the extension coupling shown in FIG. 5;

FIG. 7 is a bottom plan view, in partial cross-section, showing the interconnection of the extension coupling of FIGS. 5 and 6 into a fifth-wheel hitch;

FIG. 8 is a side view in elevation showing the use of the extension coupling of the present invention with a truck and trailer combination;

FIG. 9 is a perspective view of a fifth-wheel hitch illustrating the kingpin receiver and V-notch;

FIG. 10A is a top plan view of the retainer, according to the exemplary embodiment of the present invention, illustrating a first wedge angle;

FIG. 10B is a top plan view of the retainer assembly similar to FIG. 10A illustrating a second wedge angle;

FIG. 11 is a perspective view of the retainer as viewed from above, with some of the components not illustrated for sake of simplicity;

FIG. 12 is a perspective view of the retainer as viewed from below, with some of the components not illustrated for sake of simplicity;

FIG. 13 is an exploded perspective view of the retainer as viewed from above; and

FIG. 14 is an exploded perspective view of the retainer as viewed from below.

### DETAILED DESCRIPTION OF THE EXEMPLARY EMBODIMENT

The present invention is directed to the interconnection of a tractor vehicle to a trailer with an extension coupling that mounts to the standard hitch box on the trailer and includes a forwardly projecting elongated arm that has a proximal end pivotally connected to the mount and a distal end that has a connecting pin. The invention particularly concerns a retainer which connects to the arm and engages an existing tow hitch on the tractor vehicle thus to resist rotation of the arm relative to the tow hitch. The present invention is specifically useful for fifth-wheel trailers to be pulled by pick-up trucks. Accordingly, the present invention is described with respect to such a truck/trailer combination; however, it should be understood that the present invention may be used in other applications, as well.

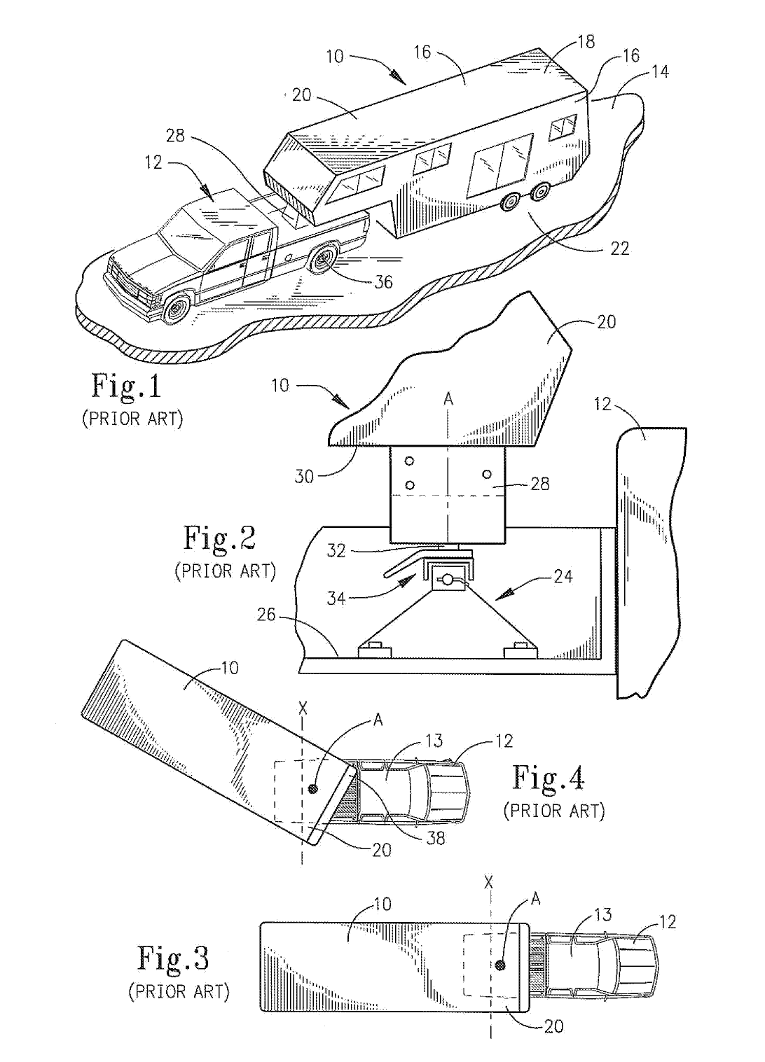

A trailer hitch coupling for a fifth-wheel trailer according to my U.S. Pat. No. 5,890,728, issued Apr. 6, 1999, is hereby incorporated, in its entirety, by reference. According to this patent and as is generally shown in FIGS. 1 and 2, it may be seen that a fifth-wheel trailer 10 is adapted to be towed by a tractor vehicle in the form of a short bed pick-up truck 12 so that it may be moved along a transport surface such as a roadway 14. Trailer 10 has a housing 16 having a rear portion 18 and a front portion 20. Rear portion 18 of housing 16 is supported on the surface of roadway 14 by means of a wheel set 22. Front portion 20 of housing 16 is connected to truck 12 and is supported thereby.

With reference now to FIG. 2, it may be seen that the traditional interconnection of trailer vehicle 10 to truck 12 is accomplished by a fifth-wheel bed hitch 24, which is mounted in the bed 26 of truck 12. Insofar as the fifth-wheel bed hitch 24 is of a standard type, such as the Reese Classic 18, its structure is not completely described herein. In any event, though, a connector box 28 is secured to mounting plates on front portion 20 of trailer 10 so that connector box 28 downwardly depends from an underside 30 of front portion 20. A connector pin, or kingpin, 32 depends downwardly from connector box 28 and is engaged by a cooperative double-acting releasable locking mechanism 34 provided on bed hitch 24. With this mounting, trailer 10 may rotate about a vertical axis “A” that is oriented slightly forwardly of the rear axle for rear wheels, such as rear wheels 36 (FIG. 1).

It is important that bed hitch 24 be mounted as close to the rear axle of truck 12 as possible so as to allow the weight of trailer 10 to be supported directly above the axle. It is desirable, though, that the bed hitch 24 be mounted slightly forward of the rear axle in order to diminish the likelihood that truck 12 will “rear” onto its back tires 36 with the front tires having diminished contact with the roadway 14 or other support surface. The tendency of the vehicle to rear under heavy loads is substantially increased if bed hitch 24 is either mounted directly above or rearwardly of the rear axle of truck 12.

With reference now to FIGS. 3 and 4, a disadvantage of the prior art before my U.S. Pat. No. 5,890,728 may now be appreciated where truck 12 is a short bed pick-up truck. Here, it may be seen that, in order to keep the bed hitch forwardly of the rear axle, so that axis “A” is forward of the rear axle, as is represented by transverse axis “X” results in diminished spacing between cab 13 of truck 12 and forward portion 20 of trailer 10. While towing trailer 10 in a straight line, as is shown in FIG. 3, this causes no problems. However, the turning radius of the combination of truck 12 and trailer 10 is diminished, as is shown in FIG. 4. When the vehicle is making a turn, the corner 38 of forward portion 20 can contact cab 13 which can result in damage to truck 12, trailer 10 or both. The extension coupling of my U.S. Pat. No. 5,890,728 helped resolve this problem, and the present invention enhances that solution by providing a more versatile retainer assembly.

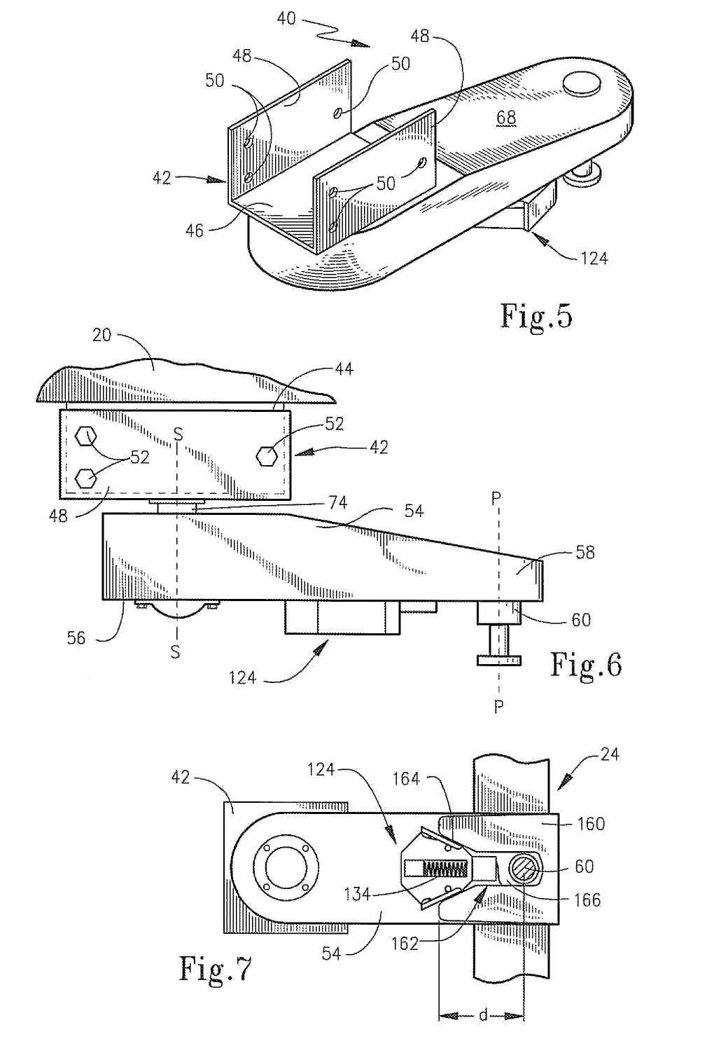

With reference now to FIGS. 5-7, it may be seen that extension coupling 40 is constructed to interconnect with a standard bed hitch 24 so as to maintain the load point of trailer 10 forwardly of the rear axle of the truck while at the same time displacing the trailer 10 a selected distance rearward of truck 12. Moreover, the present invention maintains the pivot axis for trailer 10 at the existing connector box attachment, all as described more thoroughly below.

Turning to FIG. 5, then, it may be seen that extension coupling 40 includes a mount 42 that is adapted to be secured to the trailer such as to mounting plates 44 which downwardly depend from front portion 20. Mount 42 includes a base plate 46 from which a pair of opposed, parallel side plates 48 upwardly extend. Mounting holes 50 are formed in side plate 48 and are positioned to engage plates 44 on front portion 20 of trailer 10. As is shown in FIG. 6, mount 42 may be secured to plates 44 by means of nut and bolt sets 52 as is known in the art.

An elongated arm 54 has a proximal end portion 56 that is pivotally secured to mount 42 and a distal end portion 58 that is opposite proximal end portion 56. Distal end portion 58 supports a connector pin 60 of a standard type. Connector pin 60, of course, is adapted to releasably mate with the tow hitch on the tractor vehicle. Accordingly, connector pin 60 depends downwardly from distal end portion 58 along a pin axis “P”. In use, axis “P” is general vertical of the transport surface. A retainer 124, described more thoroughly below, is located on the lower surface of arm 54 so that it projects toward connector pin 60 radially of axis “P”. Broadly, retainer 124 includes a head assembly 125 slidably disposed on a rail 190.

With reference now to FIG. 7, it may be seen that connector pin 60 and retainer 124 are adapted to engage fifth-wheel tow hitch 24 so as to resist rotation of arm 54 relative to the tow hitch 24. As is shown in this figure, tow hitch 24 has a bracket 160 including a slot 162 that is sized to receive connector 60. Slot 162 terminates in a V-shaped opening 164, which facilitates entry of pin 60 into slot 162 when the trailer is coupled to the vehicle. It may now be seen in this figure, when connector pin 60 is received in hitch 24, the triangular shape of retainer 124 engages V-shaped opening 164 of bracket 160 with this engagement compressing spring 134 into a compressed state. The action of spring force caused by spring 134 thus is in a radial direction to pin axis “P” and serves in conjunction with the triangular shape of retainer 124 to resist rotation of arm 54 relative to the tow hitch 24. Accordingly, trailer 10 is confined for pivoting about spindle axis “S”.

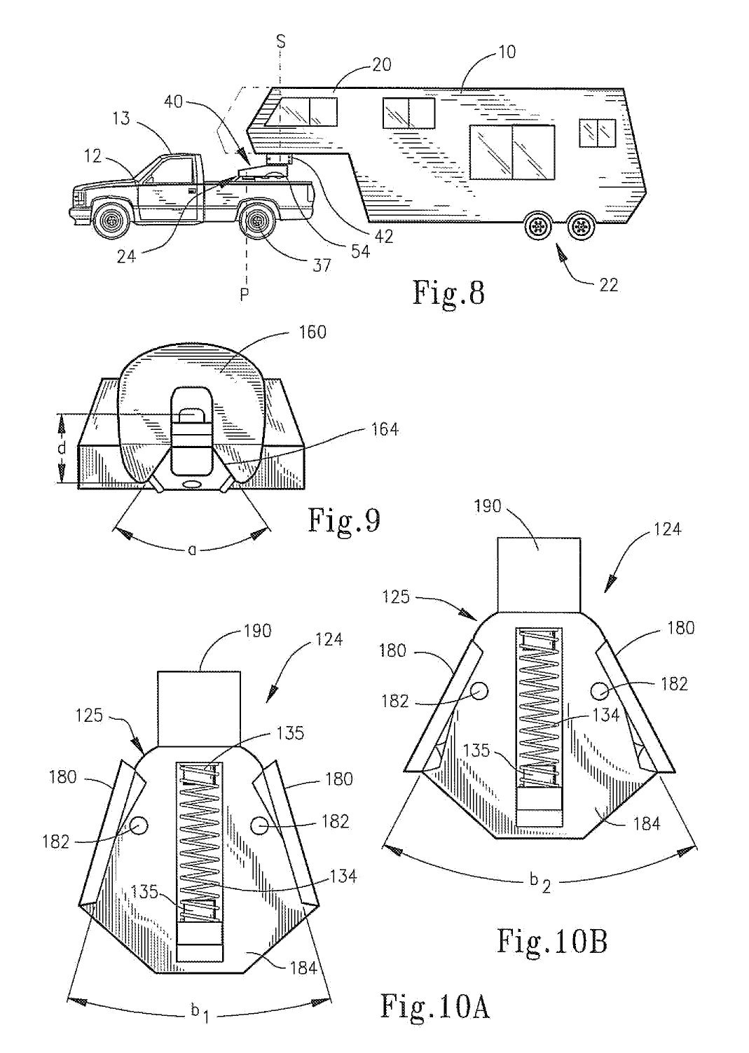

With reference now to FIG. 8, it may be seen that, by using extension coupling 40, the forward weight of trailer 10 is supported by tow hitch 24 forwardly of rear axle 37 while at the same time extension arm 54 acts to displace the position of trailer 10 rearwardly from the position shown in phantom. This allows a greater clearance between cab 13 and front portion 20 so that the turning angle between truck 12 and trailer 10 may be increased without risking damage to either trailer 10 or cab portion 13. At the same time, trailer 10 may pivot during turning about spindle axis “S” in a standard manner since arm 54 does not pivot significantly with respect to hitch 24 due to retainer assembly 124, described below.

FIG. 9 illustrates the fifth wheel hitch in more detail. In particular, it illustrates the angle “a” of V-shaped opening 164, which leads into the kingpin receiver. Angle “a” varies based on the manufacturer as well as the weight rating of the tow hitch. In order to prevent swing arm 54 from rotating about kingpin 60 in the fifth wheel hitch, head assembly 125 of retainer 124 must fit snugly with V-shaped opening 164 (see FIG. 7). The distance “d” between the V-shaped opening 164 and the kingpin receiver 166 can also vary depending on the manufacturer. The present invention is designed to accommodate both of these variations in trailer hitch design.

FIGS. 10A and 10B illustrate how the head assembly 125 has a variable wedge angle, which mates with angle “a” of V-shaped opening 164. Here, also, it may be seen that head assembly 125 includes a head member 184, a pair of pivot members 180 along with associated biasing springs. FIG. 10A shows head assembly 125 in a first configuration, where exterior faces 181 of pivot members 180 are positioned in respective planes oriented at an acute angle “b₁”. In FIG. 10B, the planes of exterior faces 181 of pivot members 180 are positioned to form angle “b₂”, which is a smaller acute angle than angle “b₁”. Head assembly 125 automatically adjusts between angle “b₁” and “b₂” to match angle “a” depending on the design of the hitch. In order to accommodate variations in distance “d” between the V-shaped opening 164 and the kingpin receiver opening 166, head assembly 125 also translates in a longitudinal direction radially of the connector pin. This is achieved by allowing head member 184 to translate along dovetail rail 190. When connector pin 60 is locked in hitch 24, compression spring 134 provides a restorative force biasing head assembly 125 in V-shaped opening 164 to resist rotation of arm 54 relative to the hitch. The assembly and operation of retainer 124 is described in more detail below.

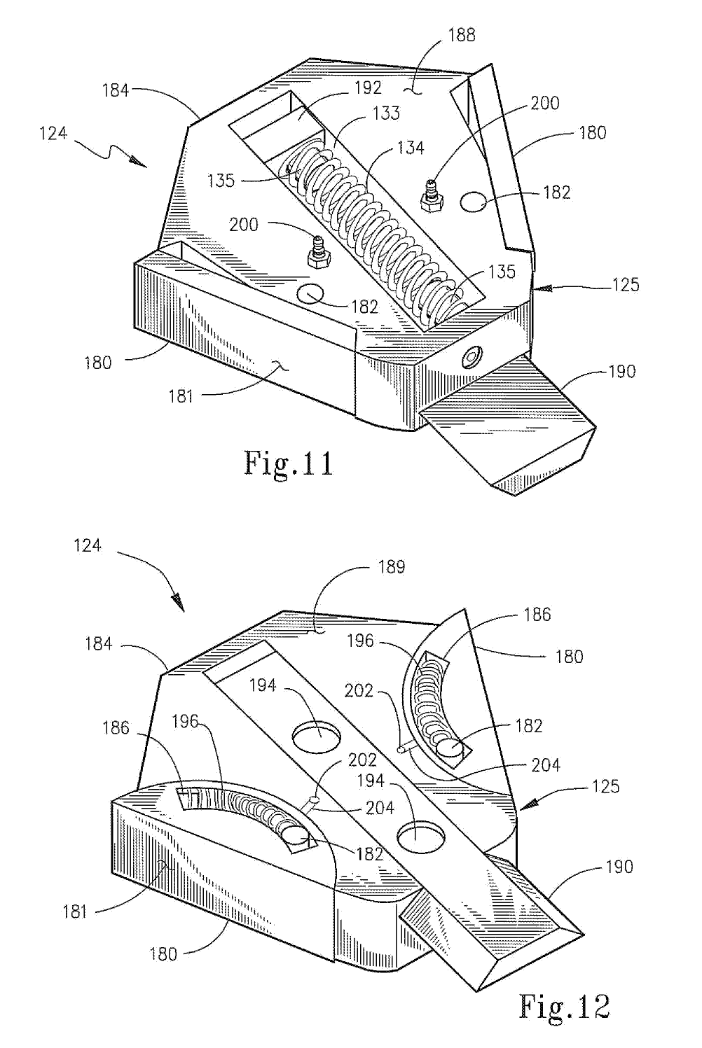

Referring now to FIG. 11, rail 190 includes a spring stop 192, which provides the resistance for compression spring 134. Wedge body 184 translates rearwardly along the axis of compression spring 134 to compress spring 134. FIG. 12 shows the underside of retainer 124. In this view the operation of the pivot members 180 can be seen more clearly. Pivot members 180 each include an arcuate slot 186, in which pin 182 is allowed to ride. The rotation/translation of each pivot member 180 is resisted by force provided by a compression spring 196, which is inserted into a respective arcuate groove 186.

Also shown this view is the underside of rail 190. Rail 190 is, in this case, configured as a dovetail with a pair of mounting holes 194, through which countersunk fasteners may be inserted in order to fasten slider rail 190 to arm 54. It should be understood that slider rail 190 remains stationary relative to arm 54, whereas wedge body 184 can translate along slider 190 and against spring 134.

In order to provide smooth operation of rail 190, as well as wedge walls 180 grease paths are provided. As shown in FIG. 11 grease fittings 200 communicate with grease path 202, which is formed through wedge body 184 from its topside 188 through to the bottom side 189. Grooves 204 are formed in the lower surface 189 of wedge body 184, thus providing a path for grease to flow to the sliding surfaces of pivot members 180. It should also be noted that grease passage 202 intersects the dovetail groove 185 of wedge body 184 (see FIG. 14).

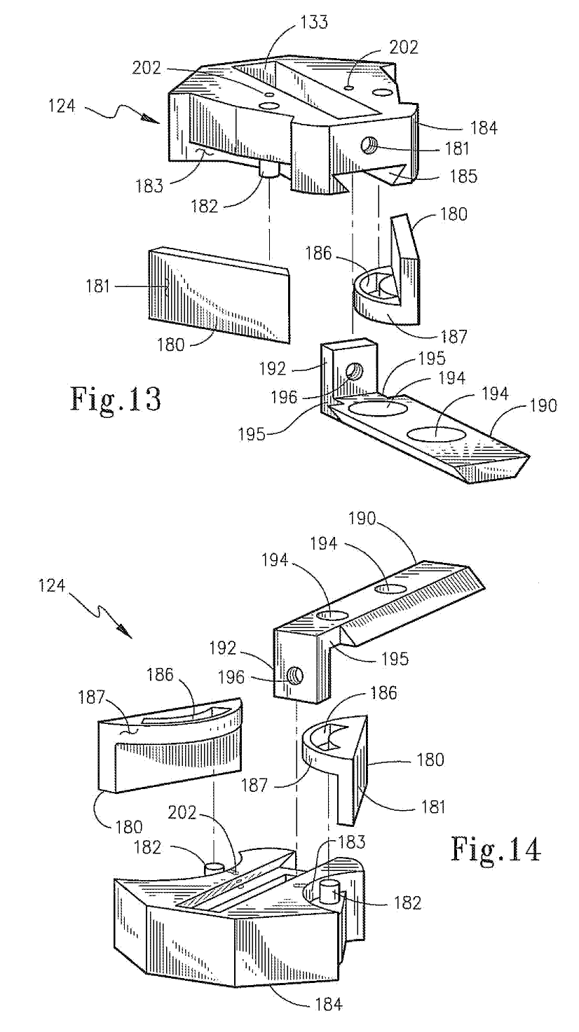

FIGS. 13 and 14 are exploded views of retainer 124 with various components removed for clarity. In this view it can be better understood how the retainer 124 is assembled. In particular, the rail 190 is inserted into the dovetail groove 185 of wedge body 184. It should be noted that the dovetail does not extend the entire length of the rail. Notches 195 allow the rail 190 to be inserted into the dovetail groove 185 of the body. Also shown in this view is the assembly of pivot members 180. Pivot members 180 are assembled onto pins 182 with arcuate surface 187 in mating relationship to arcuate surface 183. Once assembled, retainer 124 is fastened to arm 54 with flathead screws (not shown) inserted through counter sinks 194. The countersink hardware secures the entire assembly to arm 54. It should be noted that springs 196 as well as pivot members 180 and wedge body 184 are captive once the slider 190 is mounted to arm 54. Spring 134 is retained in cavity 133 of wedge body 184 with spring retainers 135. Spring retainers 135 are attached using socket head cap screws, which are fastened into threaded bore 181 of the wedge body 184 and threaded bore 196 of slider stop 192.

FIG. 14 also illustrates the assembly of the wedge assembly 124. Pivot members 180 rotate along the juncture of surfaces 187, where they meet arcuate surfaces 183 of the wedge body 184. When retainer 124 is in the mounted state the pivot members 180 are retained by pins 182 and captured between the wedge body 184, and the surface of arm 54. Referring again to FIG. 12, compression springs 196 are inserted into grooves 186 between the end of the groove and pin 182. The springs 196 are held captive in the groove between wedge body 184 and the surface of arm 54. As noted earlier, grease passage 202 intersects dovetail groove 185, thereby providing grease to the dovetail slide as well as to the rotational sliding surfaces 183, 187 of pivot members 180.

With reference to FIGS. 11-14, the assembly of retainer 124 is described. First, rail 190 is inserted into wedge body 184. Next pivot members 180 are assembled to pins 182 on the underneath of wedge body 184. Compression springs 196 are installed in grooves 186 as shown in FIG. 12. Wedge body 184, along with pivot members 180 and rail 190 are fastened to arm 54 with flathead hardware through counter sinks 194. At this point, wedge body 184, as well as wedge walls 180 and springs 196 are now captive and held in place with the rail. Next, spring retainers 135 are assembled to the wedge body 184 and spring stop 192 with socket head cap screws. Next compression spring 134 is compressed and inserted in between spring retainers 135 and then allowed to expand. Finally grease fittings 200 are threaded into grease passages 202.

Accordingly, the present invention has been described with some degree of particularity directed to the exemplary embodiment of the present invention. It should be appreciated, though, that the present invention is defined by the following claims construed in light of the prior art so that modifications or changes may be made to the exemplary embodiment of the present invention without departing from the inventive concepts contained herein.

I claim:

1. An extension coupling for releasably interconnecting a trailer to a tow hitch having an angular opening, comprising:
(A) a mount adapted to be secured to the trailer;
(B) an elongated arm having a proximal end portion rotatably attached to said mount and a distal end portion opposite said proximal end portion;
(C) a connector pin disposed on said distal end portion and adapted to releasably mate with the tow hitch; and
(D) a retainer mounted to said elongated arm and associated with said connector pin and including a head assembly operative to engage the angular opening of said tow hitch thereby to resist rotation of said arm relative to said tow hitch, said head assembly providing first and second faces respectively oriented in first and second planes that are at an angle with respect to one another, said first and second faces being movable with respect to one another so as to change the angle between a larger angle and a smaller angle to correspond to the angular opening in said tow hitch.

2. An extension coupling according to claim 1 wherein said head assembly is slideably mounted to said elongated arm.

3. An extension coupling according to claim 2 wherein said connector pin projects from the distal end portion along a pin axis, and wherein said head assembly is biased toward said connector pin.

4. An extension coupling according to claim 1 wherein said retainer includes a rail disposed on said arm and a head member slideably secured to said rail for movement toward and away from said connector pin.

5. An extension coupling according to claim 4 wherein said rail has a dovetail cross-section and wherein said head member has a dovetail channel sized and adapted to engage said rail.

6. An extension coupling according to claim 4 wherein said retainer includes a spring oriented to bias said head member toward said connector pin.

7. An extension coupling according to claim 6 wherein said head member includes a cavity formed therein, said spring being located in said cavity.

8. An extension coupling according to claim 7 wherein said rail includes a spring stop projecting into said cavity, said spring having one end supported by said spring stop.

9. An extension coupling according to claim 1 wherein said head assembly includes a head member and first and second pivot members pivotally disposed on said head member and respectively providing the first and second faces, said first and second pivot members operative to pivot between a first position corresponding to the larger angle and a second position corresponding to the smaller angle.

10. An extension coupling according to claim 9 wherein said first and second pivot members are biased toward said first position.

11. An extension coupling according to claim 9 wherein said head assembly is structured as a wedge.

12. An extension coupling according to claim 1 wherein said mount includes a flat base plate and a pair of upwardly projecting side plates disposed on said base plate in spaced-apart opposed relation to one another, said side plates sized and adapted to releasably engage said trailer.

13. An extension coupling for releasably interconnecting a trailer to a tow hitch having an angular opening, comprising:
(A) a mount adapted to be secured to the trailer;
(B) an elongated arm having a proximal end portion rotatably attached to said mount and a distal end portion opposite said proximal end portion;
(C) a connector pin disposed on said distal end portion and adapted to releasably mate with the tow hitch; and
(D) a retainer mounted to said elongated arm and associated with said connector pin and including
(1) a rail disposed on said arm,
(2) a head assembly head member slideably secured to said rail for movement toward and away from said connector pin, said head assembly providing first and second faces respectively oriented in first and second planes that are at an angle with respect to one another, said first and second faces being movable with respect to one another so as to change the angle between a larger angle and a smaller angle to correspond to the angular opening in said tow hitch, and
(3) a spring oriented to bias said head member toward said connector pin,
said head assembly operative to engage the angular opening of said tow hitch thereby to resist rotation of said arm relative to said tow hitch.

14. An extension coupling according to claim 13 wherein said head assembly includes a head member and first and second pivot members pivotally disposed on said head member and respectively providing the first and second faces, said first and second pivot members operative to pivot between a first position corresponding to the larger angle and a second position corresponding to the smaller angle.

15. An extension coupling according to claim 14 wherein said first and second pivot members are biased toward said first position.

16. An extension coupling according to claim 15 wherein said head assembly is structured as a wedge.

17. A trailer towable by a tractor vehicle that has a tow hitch with an opening, said trailer being releasably interconnectable to said tow hitch whereby said trailer is movable by said tractor vehicle, comprising:
(a) a trailer housing;
(b) a wheel set associated with said trailer housing and supporting said trailer housing for advancement along a roadway;
(c) a hitch connecting station including a pair of downwardly depending mounting plates disposed on a front portion of said trailer housing;
(d) a coupling operative to interconnect said trailer housing and said tow hitch whereby said trailer can pivot about a vertical pivot axis that is located at said hitch connecting station while resisting rotation about a vertical pin axis that is located at the tow hitch, said coupling including:
(i) a mount adapted to be secured to the trailer;
(ii) an elongated arm having a proximal end portion pivotally attached to said mount and a distal end portion opposite said proximal end portion;
(iii) a connector disposed on said distal end portion and adapted to releasably mate with the tow hitch; and
(iv) a retainer mounted to said elongated arm and associated with said connector pin and including a head assembly operative to engage the angular opening of said tow hitch thereby to resist rotation of said arm relative to said tow hitch, said head assembly providing first and second faces respectively oriented in first and second planes that are at an angle with respect to one another, said first and second faces being movable with respect to one another so as to change the angle between a larger angle and a smaller angle to correspond to the angular opening in said tow hitch.
